(19) United States
(12) Patent Application Publication
(10) Pub. No.: US 2004/0129501 A1
(43) Pub. Date: Jul. 8, 2004

(54) Gearless cable lift with a dual wind drive disk mechanism

(76) Inventors: Horst Wittur, Karlsfeld/Rothschwaige (DE); Dietmar Kuntscher, Dresden (DE); Klaus Fichtner, Dresden (DE)

Correspondence Address: Welsh & Katz, Ltd., Thomas R. Vigil, 22nd Floor, 120 South Riverside Plaza, Chicago, IL, 60606, US

(21) Appl. No.: 10/612,334

(22) Filed: Jul. 2, 2003

(30) Foreign Application Priority Data
Jan. 4, 2001 (DE) 101 00 707.8
Aug. 10, 2001 (DE) 101 39 339.3

(51) Int. Cl. B66B 11/08

(52) U.S. Cl. 187/254; 187/264; 187/266

(57) ABSTRACT

The invention relates to a gearless cable lift with a drive disk mechanism which is dually wound by several bearer cables, comprising a counter disk (3), an elevator car (6), guide tracks for the elevator car (6) and a counter weight, especially for installation with a machine room. According to the invention, the bearer cables are guided in semicircular grooves and the ratio of the drive disk diameter to the nominal diameter of the bearing cables is 40.

The invention pertains to a gearless cable-operated elevator with a driving sheave drive twice wrapped by several parallel carrier cables, and with counter-sheave, a cage, guide rails for said cage and a counterweight for a power-room-free installment of said elevator machine.

In cable-operated elevators cage and counterweight are mutually connected by the carrier means “cable”. The counterweight balances the dead weight of the cage and part, at least one half, of the useful load as well as half of the dead weight of the elevator cables leading to the cage. For safety reasons at least two carrier cables running in parallel are obligatory. Nowadays, cable-operated elevators are equipped with driving sheave drives instead of the cable drum drives used in the past, wherein the driving sheave also can be embodied as driving rim. As driving unit electromotors are used. Driving sheave and driving motor including the energetic and control parts thereof are essential components of a gearless elevator machine. Gearless elevator machines are extremely low in noise as well as small and favorable in costs. They are much more advantageous than elevator machines with gear. They do not require gear oil dangerous for the environment and due to the omission of the gear efficiency is improved.

The elevator machine is mounted in a separate machine room or also directly in the vehicle shaft. In the latter case it can be mounted in the upper or lower portion of the shaft, laterally in the room for the counterweight or directly on or under, resp., the cage. Depending on the kind of installation, the useful cage load and other facts, like lifting height or lifting speed, different carrier cable guidances have developed.

In the most simple case, i.e. single-cable suspension the carrier cable coming from the cage is guided over the driving sheave fixedly mounted in the shaft head or in the machine room located thereabove, to the counterweight. However, there also are other carrier cable guidances in multiple-cable suspensions which using loose pulleys at the same time realize a given transmission ratio of cable speed to cage speed. If e.g. the cable drive is embodied with loose pulley on the cage and a loose pulley on the counterweight, the torque of the drive motor is reduced to one half in case of double speed. The machine will be smaller and installation in the elevator shaft does create less problems.

In order to increase or achieve the required driving capacity it is known to chose a “double wrap” which then is embodied in connection with semicircular grooves favorable in terms of noise and wear.

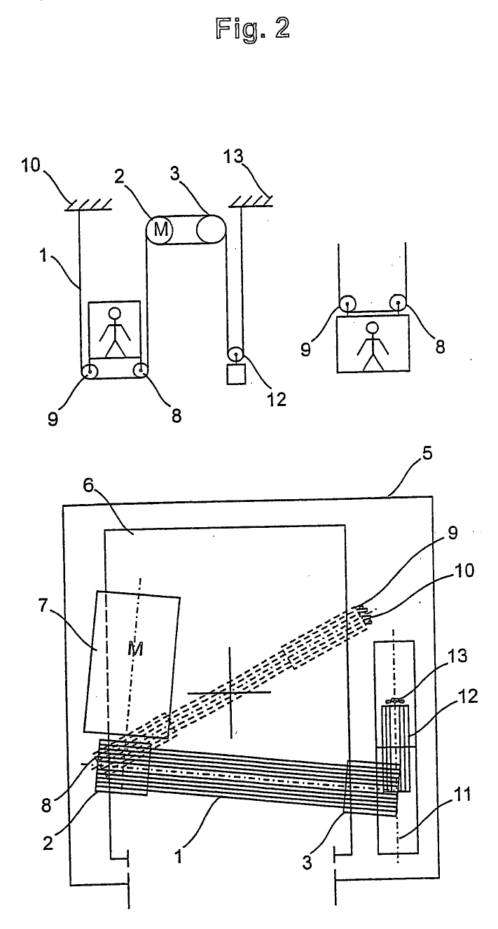

An arrangement with double wrap by two or more parallel carrier cables is described in DE 36 34 859 A1, e.g. The carrier cables extending from the cage to the counterweight are twice wound around the drive sheave and between these loops are once wound around a deflection sheave, wherein the angle of contact between the drive sheave and the carrier cables in both loops around the deflection sheave exceeds 180 degrees. A modification with double wrap and two deflection sheaves is shown in FIG. 2c of EP 0 578 237 A1.

An arrangement without machine room, with double wrap of the drive sheave is shown in WO 99/43595. According to FIG. 2 the carrier means coming from an upper cable stop extends in double around driving sheave and counter sheave which both are mounted on the cage bottom, further extends to bottom where it is deflected on a fixed sheave and finally extends over a loose pulley on the counterweight to a second upper cable stop. Drive sheave and counter sheave have such mutual distance to one another that a deflection sheave on the cage bottom is rendered superfluous. As carrier means two parallel flat cable trains are provided for, as e.g. stated more closely in WO 99/43885. Further flat cable trains are shown e.g. in WO 98/29237. Flat cable trains in contrast to the common round cables consist of several small metallic or non-metallic cords or ropes extending in parallel, which commonly are enclosed by a flat-band-shaped non-metallic sheathing. The cord thickness under WO 99/43885 permit flat cable trains of extremely low thickness In accordance with a common calculation rule, according to which the drive sheave diameter is to correspond at least to 40-times the carrier cable diameter, drive sheave diameters of 100 mm and less will result. Small drive sheave diameters often have a direct proportional effect on the torque to be created and thus to the structural size of the drive motors. I.e. the smaller the drive sheave diameter, the less torque has to be applied to the drive sheave and the more compact and Favorable in costs the drive motor can be constructed.

According to the above explanations small drive sheave diameters are particularly favorable in elevator construction, as they permit a compact construction of the drive motor. Small drive sheaves, however, include the disadvantage that the carrier cable is stressed more and the livespan of the cable is reduced thereby. In order to guarantee sufficient cable livespan in elevators under the prior art, therefore, drive sheave diameters of at least 40-times the carrier cable diameter are used, wherein reduction of carrier cable diameter is achieved by using the above-described flat cable trains as drive cables with particularly small diameter.

A disadvantage in the flat cable trains, however, is the requirement of manufacture and store-keeping of special, quite expensive carrier means for all carrier load sizes. In addition, beginning damage on the carrier means which may cause sincere danger for the elevator operation or even for the safety, can be detected with substantial technological expense or even not at all.

The invention is based on the object of further developing a gearless cable-operated elevator with double wrap in such way that the drawbacks of the flat cable trains are avoided and the elevator shows a compact construction which also is favorable in terms of costs.

In accordance with the present invention the object is solved by the features cited in claim 1. Preferred embodiments are stated in the depending claims 2 to 21.

Instead of two or three extremely thin flat cable trains, in the elevator in accordance with the present invention always equally thin carrier cables are used, wherein the ratio of the drive sheave diameter to the nominal diameter of the carrier cables is ≦40. A ratio of essentially 30 therein turned out to be very advantageous. Hereby, small drive sheave diameters are rendered possible, this guaranteeing a compact construction also favorable in terms of costs, of the drive motor. The reduced cable livespan resulting from a reduced drive sheave diameter, in accordance with the present invention is avoided by the use of semicircular drive grooves in which the carrier cables are running. It is true that the use of semicircular grooves reduces the driving capability of the drive sheave, however, this is compensated for by the use of a double wrapping. The carrier cables run in different drive grooves, however, also drive grooves with minor interference, preferably 1 to 3 mm, can be used. Such minor interference can have a positive effect on the running properties.

The driving torque can be severely reduced in the cable train in accordance with the present invention, the drive machine also becoming smaller thereby. On the other hand, the carrier cables do not experience such an extreme bending radius and such extreme rolling speeds as flat cable trains on drive sheaves with a diameter of ≦100 mm.

The thin carrier cables extremely well bear in the semicircular grooves exactly fitted to the drive sheave diameter, of the drive sheave, this avoiding deformation of the cable and cross-squeezing and reducing surface pressure. The carrier cables thereby achieve high service life. Due to the circular cross-section of the carrier cables, the cables always are “located” in the semicircular grooves exactly fitted in size, of the drive sheave. They, therefore, do not have any tendency to move out of their beds due to vibrations or uneven load. In addition, the noise is reduced in a magnitude not to be underrated.

The invention thus is based on the finding that by a combination of a double wrap of the drive cable and the guidance in semicircular grooves the ratio of drive sheave diameter to nominal diameter of the carrier cables can be reduced, this guaranteeing smaller carrier cable diameters and thus a less expensive construction of the cable-operated elevator with unreduced long cable livespan.

A further advantage lies in that it is not required to keep on store different cable sizes or flat cable train widths. One can do with drive sheaves of one groove size, wherein one drive sheave can simultaneously be intended for a large or the entire useful load range.

Visual control of the carrier cables for fatigue defects, manual feeling for wire break using sensor tools and heat dissipation from the carrier cables is substantially safer and much easier as compared to synthetic flat cable trains. Breaking of a cord, coning, squeezing, strong wear or corrosion of the individual wires cannot at all visually or only partly by magneto-inductive processes be detected in flat cable trains with plastic sheathing. The costs for manufacture and obtaining of round cables is substantially less as compared to flat cable trains. There is no danger of damages by marten bites as cannot be excluded in case of flat cable trains with plastic sheathing. In case of different lengths of the individual cords or individual cables of a flat cable train with plastic sheathing the entire flat cable sheathing will warp and the driving capacity thereof and the service life will be reduced.

In a particularly preferred embodiment of the present invention particularly thin carrier cables with a nominal diameter between 5 to 7 mm, in particular of ≦6 mm are used. With a plurality of such thin carrier cables adaptations to the useful cage load can be carried out in more sensible steps. As well, lubrication and cleaning of thin cables is much more efficient as is the case in thicker cables. As compared thereto, in elevators with flat cable trains with plastic sheathing or few thick carrier cables larger steppings have to be accepted for adaptation to carrying capacity of an elevator. Since non-dimensioning is out of discussion for elevators, the cables always will be over-dimensioned, this rendering the elevator system more expensive.

The invention will now be explained in more detail with reference to the embodiments. In the relating drawing

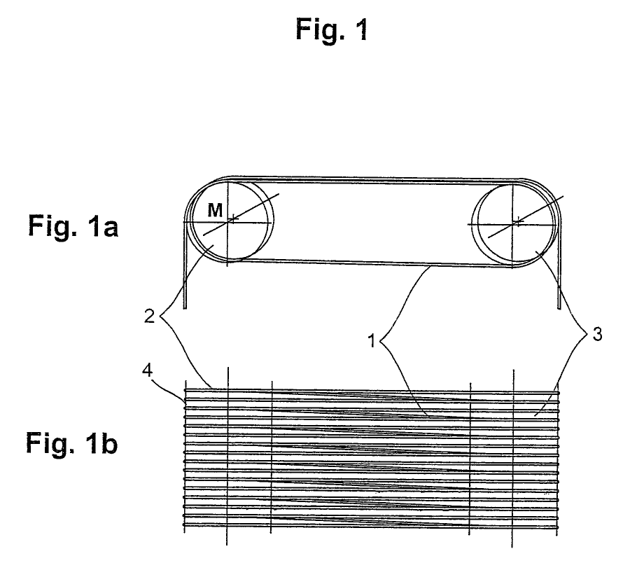

FIG. 1a shows a principal view of a cable drive with double wrap in side view and

FIG. 1b in top view;

FIG. 2 shows an example of a shaft head installation and 2 to 1 suspension;

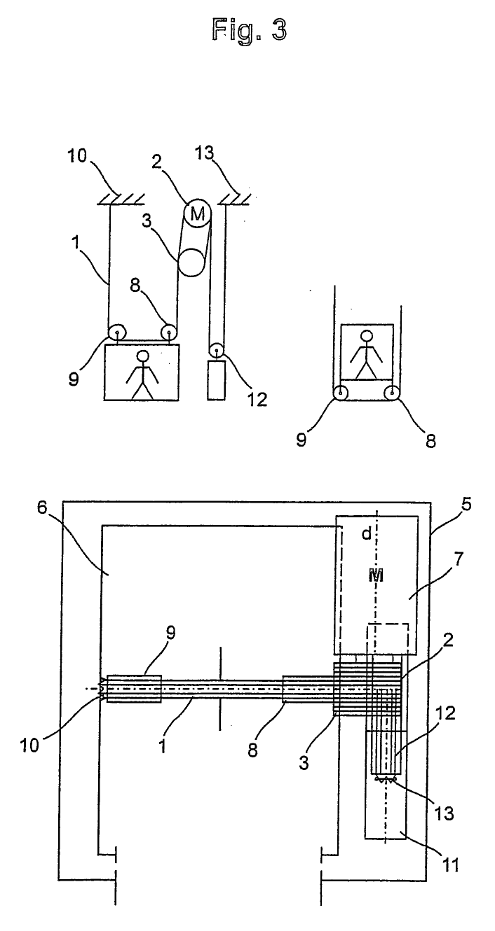

FIG. 3 shows an example of a shaft wall installation and 2 to 1 suspension;

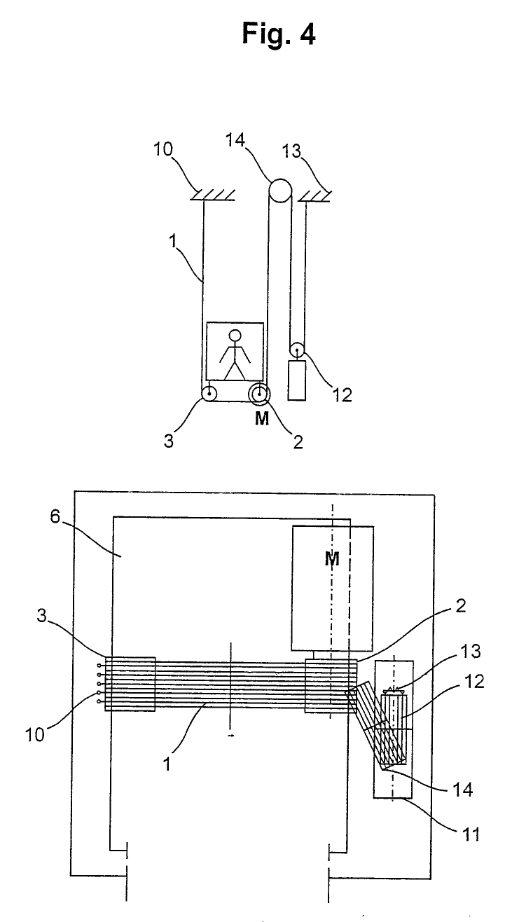

FIG. 4 shows an example of a cage bottom installation and 2 to 1 suspension; and

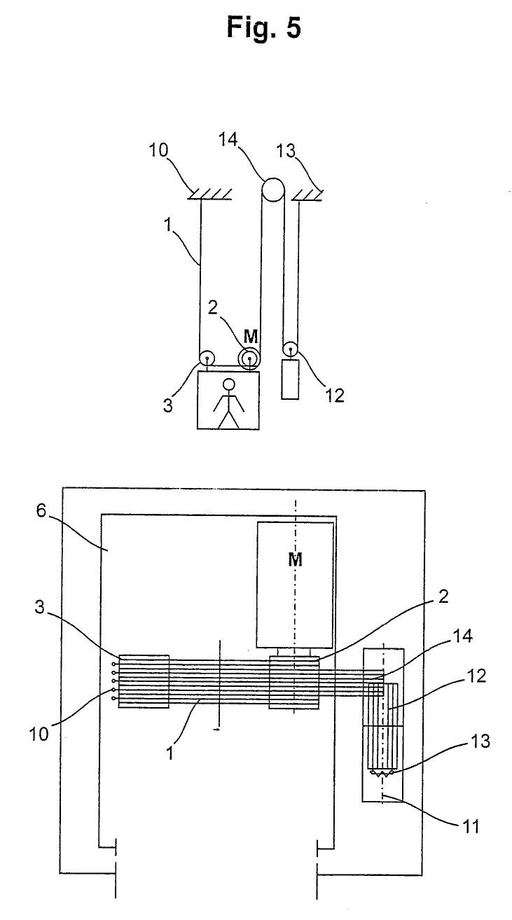

FIG. 5 shows an example of a cage cover installation and 2 to 1 suspension.

In FIG. 1 a cable-operated drive known per se, with double wrap is shown in more detail. A set of carrier cables 1 in the example consisting of 8 carrier cables extending in parallel, with a nominal diameter of 6 mm, is—coming from bottom—guided over a drive sheave 2 with a nominal diameter of 240 mm and semicircular grooves 4 to a counter sheave 3 also having a nominal diameter of 240 mm, is wrapped around said counter sheave 3, runs back to said drive sheave 2, is wrapped around said drive sheave 2, runs back to said counter sheave 3 and is again guided downwardly over the latter. Instead of said drive sheave with a nominal diameter of 240 mm also such with lower nominal diameter can be used. For example, the nominal diameter can amount to 180 mm only, this corresponding to a ratio of drive sheave diameter to nominal diameter of the carrier cables of 30.

In FIG. 1a for better overview, only one of said 8 carrier cables of said carrier cable set 1 is shown. Said drive sheave 2 and counter sheave 3 are shown arranged horizontally with respect to one another. As well, they can be arranged perpendicularly to one another. The distance of counter sheave 3 to drive sheave 2 is chosen such that in case of horizontal sheave arrangement in the shaft head said carrier cable set 1 runs on the outside of the cage sides not shown in FIG. 1. Thereby, an additional deflection sheave otherwise required can be done without.

From FIG. 1b is can be seen that said counter sheave 3 is displaced with respect to said drive sheave 2 by a given amount, as a rule by half of the cable center distance. Drive sheave 2 and counter sheave 3 in addition can be slightly turned with respect to the vertical axis in order to account for the helical wrapping, wherein dais carrier cables alternatively bear in the area of the double wrap. Cable deflection can be minimized in this manner. Said carrier cables run in semicircular grooves of said drive sheave 2, which are adapted to the nominal diameter of said carrier cables and corresponding grooves of said counter sheave 3. This not only guarantees accurate cable guidance and high livespan but also excellent carrying capacity due to the plane support. In case of interfering seat grooves said carrier cables would bear only on part of the possible cable surface. Thereby and due to the wedge effect in the cable seat cross-squeezings and deformations would occur.

With a suspension 2 to 1 and the usual conditions for cage mass and lifting height of a passenger elevator, using a carrier cable set of six 6-mm carrier cables useful cage loads up to 450 kg can be realized for cage speeds of 1 m/s. However, also higher speeds of up to 2 m/s or more are conceivable. For higher useful loads, e.g. a useful cage load of 630 kg and a moving speed of 1 m/s, about 8 carrier cables are used, depending on the breaking point of said carrier cables, and for useful cage loads between 800 kg and 1000 kg up to 12 carrier cables are used, again in dependence on the breaking point of said carrier cables.

The breaking point of said carrier cables in addition to the nominal diameter of said carrier cables also decisively depends on the material and the construction of a carrier cable. The most important technical data like tensile strength of the wires, calculative breaking force and detected breaking force, are given by the manufacturer in a certificate of conformity and serve for elevator construction for calculation of the required number of carrier cables of said carrier cable set 1. The above values, therefore, can only be informative values, in particular since the result is substantially influenced by a high safety factor depending a.o. on the nominal cable speed and the cable guidance.

In FIG. 2 an example for a machine-room-less installation of said drive sheave drive in the shaft head is shown schematically. The shaft wall 5 circumscribes the free shaft room. From top the roof of said cage 6 can be seen. Above said cage 6 the drive sheave drive with the drive motor 7, the drive sheave 2 with a corresponding nominal diameter of about 240 mm and said counter sheave 3 with a nominal diameter of about 240 mm are mounted in said shaft head in such manner that said carrier cable set 1 twice wrapping said drive sheave 2, with its 6 mm carrier cables directly runs downwardly passing the side walls of said cage, wherein one end of said carrier cable set 1 is wound around two deflection sheaves 8, 9 fixed to the cage bottom as “bottom flanges”, and runs in upward direction to a first cable stop 10 and said other end of said carrier cable set 1 is wound around a deflection sheave 12 mounted on said counterweight 11 and then extends further in upward direction to a second cable stop 13. Said counterweight 11 and its deflection sheave 12 laterally run between said shaft wall 5 and a side wall of said cage 6. The cable guidance by which a 2 to 1 transmission ratio of the cable speed at said drive sheave 2 to the cable speed with halved driving torque is achieved, is very favorable for the use of a small drive motor 7 with more speed, with smaller drive sheave 2 and thin carrier cables and schematically again is shown separately. The fixation means for said drive sheave drive in said shaft head have been omitted as have the lateral guide rails for said cage and further components of a standard cable-operated elevator.

When said drive sheave drive is mounted in a shaft pit instead of in a shaft head, two further deflection sheaves are required, this increasing the number of bending changes of said carrier cables and reducing their cable livespan. In reconstructions, however, due to building conditions it will hardly be possible to do without such solution.

FIG. 3 shows the installation of a drive sheave drive on a shaft wall 5. In this example said drive sheave 2 and said counter sheave 3 are arranged one below the other in the elongate room for said counterweight 11. Said carrier cable set 1 runs from a first cable stop 10 via said deflection sheaves 8, 9 to said drive sheave drive 3, 2, twice wraps said drive sheave 2 driven by said drive motor 7, runs to said deflection sheave 12 on which said counterweight 11 is suspended, and finally runs to said second cable stop 13. Said deflection sheaves 8, 9 can be mounted on the roof of said cage 6 as well as also under the bottom of said cage 6. Both modifications are shown schematically. The described carrier cable guidance embodies a 2 to 1 suspension.

When said drive sheave drive is solidly mounted on top of, on bottom of or laterally in said shaft, it is meaningful to mount it on the elevator frame.

In FIG. 4 said drive sheave drive is mounted on bottom of said cage 6. Said carrier cable set 1 runs from said first cable stop 10 around said counter sheave 3 and said drive sheave 2 which both are mounted on the bottom of said cage 6, further runs upwardly, over a deflection sheave 14, wraps said deflection sheave 12 on said counterweight and finally is fixed with said second end on said second cable stop 13. Again a 2 to 1 suspension is realized.

According to FIG. 5 said drive sheave drive is mounted on the roof of said cage 6. Cable guidance corresponds to cable guidance under FIG. 4. The decisive point for the choice of installation of said drive sheave drive on said cage bottom or on said cage roof finally are the local conditions in the shaft and the possibilities for a possibly unimpeded maintenance of said drive sheave drive.

When said drive sheave drive is mounted on said cage 6, said cage frame or said main cage support preferably is supplemented by corresponding holding means.

Said cage support can be effected at a ratio of 1 to 1, 2 to 1 or also 4 to 1, depending on if and how many loose pulleys are used.

As carrier cables single-layer round cord cables can be used, wherein the individual round wires are drawn from unalloyed steel with a comparatively high carbon content of 0.4 percent to 1 percent. However, it also is possible to use multiple-layer round cord cables. Furthermore, carrier cables from synthetic wires or steel and synthetic wires can be used. A preferred synthetic material is aramide e.g., as being high-rupture proof.

Said carrier cables in a preferred embodiment of the invention have a nominal diameter of 6 mm, this permitting drive sheave diameters of 240 mm and less.

An additional minimization of said drive sheave drive and for increase of its livespan is contributed to in that in a further embodiment said engine of said drive sheave drive itself is embodied without mechanical double emergency hold braking device and instead a double emergency braking device is provided for an said cage 6, which acts on both sides of at least one guide rail for said cage. 6. Preferably, then said double emergency hold braking device is a double disc clasp brake. Said electromotor according to a further preferred embodiment is realized as rectifier-controlled three-phase synchronous or three-phase asynchronous motor.

### Reference Numerals

1 set of carrier cables

2 drive sheave

3 counter sheave

4 semicircular grooves

5 shaft wall

6 cage

7 drive motor

8 deflection sheave

9 deflection sheave

10 cable stop

11 counterweight

12 deflection sheave

13 cable stop

14 deflection sheave

What is claimed:

1. A gearless cable-operated elevator with a drive sheave drive twice wrapped by several parallel carrier cables, with counter sheave (3), a cage (6), guide rails for said cage (6) and a counterweight (11), for a machine-room-free installation in particular, characterized in that said carrier cables run in semicircular grooves and the ratio of drive sheave diameter to nominal diameter of said carrier cables is 40.

2. The gearless cable-operated elevator under claim 1, characterized in that the ratio of drive sheave diameter to nominal diameter of said carrier cables essentially is 30.

3. The gearless cable-operated elevator under claim 1 characterized in that said drive grooves are without interference.

4. The gearless cable-operated elevator under claim 1, characterized in that said drive grooves have minor interference, preferably interference of 1 to 3 mm.

5. The gearless cable-operated elevator under claim 1, characterized in that said carrier cables have a nominal diameter between 5 to 7 mm, 6 mm in particular.

6. The gearless cable-operated elevator under claim 1, characterized in that it is configurated for useful cage loads of up to 2000 kg and that it comprises carrier cables with a nominal diameter of essentially 7 mm, the ratio of drive sheave diameter of essentially 7 mm, the ratio of drive sheave diameter to nominal diameter of said carrier cables preferably being about 34.

7. The gearless cable-operated elevator under claim 1, characterized in that it is configurated for useful cage loads up to 2000 kg, between 300 kg and 1000 kg in particular.

8. The gearless cable-operated elevator under claim 1, characterized in that said counter sheave (3) simultaneously is a distancing deflection sheave.

9. The gearless cable-operated elevator under claim 1, characterized in that for adaptation to the occurring cable forces alone the number of applied carrier cables is variable in said drive sheave drive.

10. The gearless cable-operated elevator under claim 1, characterized in that said drive sheave (2) and said counter sheave (3) of said drive sheave drive are vertically arranged with respect to one another and in the area of said shaft head in the area of said shaft pit.

11. The gearless cable-operated elevator under claim 1, characterized in that said drive sheave (2) and said counter sheave (3) of said drive sheave drive are arranged in perpendicular to one another and in the area of said elongated counterweight room in said shaft.

12. The gearless cable-operated elevator under claim 1, characterized in that said drive sheave (2) and said counter sheave (3) of said drive sheave drive are arranged on bottom or on the roof of said cage (6).

13. The gearless cable-operated elevator under claim 1, characterized in that said drive sheave drive is fixed to said elevator frame.

14. The gearless cable-operated elevator under claim 12, characterized in that said holding elements for said drive sheave drive are integrated in said cage frame or cage main support.

15. The gearless cable-operated elevator under claim 1, characterized in that said a cage suspension is effected with a ratio of 1 to 1.

16. The gearless cable-operated elevator under claim 1, characterized in that said a loose pulley cage suspension is effected with a ratio of 2 to 1 or 4 to 1.

17. The gearless cable-operated elevator under claim 1, characterized in that said carrier cables are steel cables, preferably single-layer round core cables.

18. The gearless cable-operated elevator under claim 1, characterized in that said motor of said drive sheave drive is a three-phase asynchronous or three-phase synchronous motor.

19. The gearless cable-operated elevator under claim 1, characterized in that said motor of said drive sheave drive is embodied without mechanical emergency stop braking device.

20. The gearless cable-operated elevator under claim 1, characterized in that said on said cage (6) a double brake is arranged as emergency stop braking device, which acts on both sides of at least one guide rail for said cage (6).

21. The gearless cable-operated elevator under claim 20, characterized in that said braking device is a double disk clasp brake.
